(19) United States
(12) Patent Application Publication
(10) Pub. No.: US 2007/0246660 A1
(43) Pub. Date: Oct. 25, 2007

(54) Radiation image phosphor or scintillator panel

(76) Inventors: Jean-Pierre Tahon, Langdorp (BE); Paul Leblans, Kontich (BE); Carlo Uyttendaele, Mortsel (BE)

Correspondence Address: NEXSEN PRUET, LLC, P.O. BOX 10648, GREENVILLE, SC, 29603, US

(21) Appl. No.: 11/716,846

(22) Filed: Mar. 12, 2007

Related U.S. Application Data
(60) Provisional application No. 60/794,431, filed on Apr. 24, 2006.

(30) Foreign Application Priority Data
Apr. 20, 2006 (EP) 06112800.5

(51) Int. Cl. G03B 42/08

(52) U.S. Cl. 250/483.1; 427/65; 250/484.4

(57) ABSTRACT

In favor of lowering corrosion of a radiation image phosphor or scintillator panel comprising, as a layer arrangement of consecutive layers, an anodized aluminum support, a sublayer and a phosphor or scintillator layer having needle-shaped phosphor or scintillator crystals, said sublayer comprises an inorganic metal oxide or a metal compound and has a thickness in the range from 0.1 μm to 2.5 μm.

### CROSS-REFERENCE TO RELATED PATENT APPLICATIONS

This application claims the benefit of U.S. Provisional Application No. 60/794,431 filed Apr. 24, 2006, which is incorporated by reference. In addition, this application claims the benefit of European Application No. 06112800.5 filed Apr. 20, 2006, which is also incorporated by reference.

### FIELD OF THE INVENTION

The present invention is related with a binderless radiation image panel provided with a vapor deposited phosphor or scintillator layer upon an aluminum support, modified in order to avoid corrosion pittings onto said aluminum support.

### BACKGROUND OF THE INVENTION

Radiation image recording systems wherein a radiation image is recorded on a phosphor or scintillator screen by exposing the screen to image-wise modulated penetrating radiation are widely used nowadays.

In the case of storage phosphor screens a recorded image is reproduced by stimulating an exposed photostimulable phosphor screen by means of stimulating radiation and by detecting the light that is emitted by the phosphor screen upon stimulation and converting the detected light into an electrical signal representation of the radiation image.

In several applications as e.g. in mammography, sharpness of the image is a very critical parameter. Sharpness of an image that has been read out of a photostimulable phosphor screen not only depends on the sharpness and resolution of the screen itself but also on the resolution obtained by the read-out system which is used.

In conventional read out systems used nowadays a scanning unit of the flying spot type is commonly used. Such a scanning unit comprises a source of stimulating radiation, e.g. a laser light source, means for deflecting light emitted by the laser so as to form a scanning line on the photostimulable phosphor screen and optical means for focusing the laser beam onto the screen.

Examples of such systems are the Agfa Diagnostic Systems, denominated by the trade name ADC 70 and Agfa Compact. In these systems photostimulable phosphor screens which comprise a BaFBr:Eu phosphor are commonly used.

The resolution of the read-out apparatus is mainly determined by the spot size of the laser beam. This spot size in its turn depends on the characteristics of the optical light focusing arrangement. It has been recognized that optimizing the resolution of a scanning system may result in loss of optical collection efficiency of the focussing optics. As a consequence an important fraction of the laser light is not focused onto the image screen. A severe prejudice exists against the use of systems having an optical collection efficiency of the focusing optics which is less than 50% because these systems were expected not to deliver an adequate amount of power to the screen in order to read out this screen to a sufficient extent within an acceptable scanning time.

A solution has therefor been sought and found as disclosed in U.S. Pat. No. 6,501,088. Therein use has been made of a method for reading a radiation image that has been stored in a photostimulable phosphor screen comprising the steps of scanning said screen by means of stimulating radiation emitted by a laser source, detecting light emitted by said screen upon stimulation, converting detected light into an electrical signal representation of said radiation image, wherein said photostimulable phosphor screen comprises a divalent europium activated cesium halide phosphor wherein said halide is at least one of chloride and bromide and said laser beam is focused so that the spot diameter of the laser spot emitted by said laser, measured between 1/e² points of the gaussian profile of said laser beam is smaller than 100 μm. Object of that invention to provide a method and a system for reading a radiation image that has been stored in a photostimulable phosphor screen was resulting, besides in a method and a system for reading a radiation image stored in a photostimu-lable phosphor screen having a needle-shaped storage phosphor layer, in a method and system yielding a high sharpness.

In US-A 2004/0149929 a radiation image storage panel has been disclosed, composed of a support, a phosphor matrix compound layer covering a surface of the support at a coverage percentage of 95% or more, and a stimulable phosphor layer (which is composed of multiple prismatic stimulable phosphor crystals standing on the phosphor matrix compound layer) formed on the phosphor matrix compound layer, thereby providing a high peel resistance between the support and the stimulable phosphor layer, a high sensitivity, and a reproduced radiation image of high quality.

However, in a radiation image transformation panel, in order to attain the desired radiation absorbing power the needle shaped europium doped cesium halide storage phosphor must be formed in a layer having a thickness of about 200-800 μm. Since the parent compound of the photostimulable phosphor consisting of alkali halide compound, such as CsBr, has a large thermal expansion coefficient of about 50×10⁻⁶/° K, cracks may appear in such a relatively thick layer so that adhesion of the storage phosphor layer onto the support substrate may become a problem, leading to delamination. Factors having a negative influence onto cracking and delamination are related, besides with substrate temperature and changes thereof during the vapor deposition process, with the pressure of inert gas in the vacuum chamber and with presence of impurities, which have a significant influence upon crystallinity of the deposited phosphor layer during said vapor deposition process. In order to solve that problem, a solution has been proposed in JP-A 2005-156411. In that application a first vapor deposited layer was formed onto the substrate, wherein said layer was containing an alkali halide compound with a molecular weight smaller than the parent compound of the photostimulable phosphor. The layer with the vapor deposited stimulable europium doped cesium halide phosphor was further deposited thereupon. Nevertheless as a first layer between substrate and storage phosphor layer is a vapor deposited layer again, same problems were met with respect to cracks and delamination and the expected improvement with respect thereto was not yet fully obtained.

In U.S. Pat. No. 6,870,167 a process for the preparation of a radiation image storage panel having a phosphor layer which comprises a phosphor comprising a matrix component and an activator component, which comprises the steps of: forming on a substrate a lower prismatic crystalline layer comprising the matrix component by vapor deposition, and forming on the lower prismatic crystalline layer an upper prismatic crystalline layer comprising the matrix component and the activator component by vapor deposition as an arrangement favorable for crystallinity of said upper layer. In favor of adhesion however it has been proposed in US-Application 2005/51736 to make use of spherical shaped phosphors in the lower layer.

When performing vapor deposition techniques in order to prepare phosphor layers onto dedicate substrates, a highly desired substrate material whereupon the scintillator or phosphor material should be deposited is made of glass, a ceramic material, a polymeric material or a metal. As a metal base material use is generally made of metal sheets of aluminum, steel, brass, titanium and copper. Particularly preferred as a substrate is aluminum as a very good heat-conducting material allowing a perfect homogeneous temperature, not only over the whole substrate surface but also in the thickness direction: such heat conductivities are in the range from 0.05-0.5 W/(m·K).

Since completely pure aluminum is not easily produced from a point of view of a refining technology, aluminum supports containing other elements in the aluminum alloy like silicon, iron, manganese, copper, magnesium, chromium, zinc, bismuth, nickel and titanium have been used as described in U.S. Pat. Nos. 3,787,249 and 3,720,508, wherein, as in automotive applications, bright anodized aluminum alloys having appearance somewhat similar to buffed stainless steels or to chrome-plated brass are much more economical to the user. Said alloys have markedly improved resistance to oxidation in the temperature range of 440° to 500° C. which results in improved surface appearance after hot rolling and are tolerant to a broader range of solution composition in which they can be bright dipped. Alloys described in U.S. Pat. No. 4,235,682 further exhibit substantially improved brightness after anodizing in sulphuric acid and sealing.

It should be noted however that in order to perform vapor deposition of two vapor deposited layers as has e.g. been described in U.S. Pat. Nos. 6,870,167 and 6,967,339, or in US-Application 2005/0077479 two different processes in a vapor depositing apparatus are required in order to deposit different raw starting materials in each layer: as it is known that increased dopant amounts in the upper layer lead to a desired higher sensitivity of the storage phosphor screen thus formed, it can be expected that higher dopant amounts lead to enhanced cracking and decreased adhesion of the coated layers. Otherwise in order to have better reflection properties in favor of reflection of light emitted upon stimulation of the storage phosphors and, as a consequence thereof, an enhanced sensitivity, it can be expected that a more mirror-like smoother support surface is not in favor of a better adhesion of phosphor layers, deposited thereupon.

Besides a good compromise between roughness, speed, cracking and adhesion, it is clear that lowering of number of corrosion pittings in the support layer due to an aggressive vapor deposition process of the binderless phosphor or scintillator onto the aluminum support will be highly appreciated.

### SUMMARY OF THE INVENTION

Although being hitherto favorable with respect to corrosion characteristics of vapor deposited phosphor or scintillator layers having a thickness of 100 μm up to 1000 μm thereupon, as causing no undesired “pittings” or delamination of scintillator or phosphor “flakes” when prepared in a vapor deposition apparatus in optimized conditions, it is a main object of the present invention to avoid corrosion of the supporting layer occurring as a consequence of vapor deposition of phosphor or scintillator layers in aggressive conditions of high temperature and low pressure and storage of said phosphor layers in high humidity conditions at elevated temperature, wherein such corrosion becomes visible in form of “pittings” in flat field phosphor panels, especially after a treatment during 7 days at 30° C. in an atmosphere having a relative humidity of 80%.

It is a further object not to negative sharpness, due e.g. to a smoother, more reflective support layer in contact with the phosphor or scintillator layer, vapor deposited thereupon.

The above-mentioned advantageous effects have been realized by providing a storage phosphor panel having the specific features set out in claim 1. Specific features for preferred embodiments of the invention are set out in the dependent claims.

It has been found now that, in order to get better protection against corrosion of a radiation image phosphor or scintillator panel comprising as a layer arrangement of consecutive layers an anodized aluminum support, a sublayer and a phosphor or scintillator layer comprising needle-shaped phosphor crystals, said sublayer advantageously comprises an inorganic compound, i.e. an inorganic metal oxide or a metal compound, and in that said sublayer has a thickness in the range from 0.1 μm to 2.5 μm.

More particular embodiments of the phosphor or scintillator panels according to the present invention are as follows:
said inorganic compound is a metal compound or a metal oxide compound;
said metal is selected from the group consisting of tin, copper, nickel, chromium, scandium, yttrium, tantalum, vanadium, titanium, niobium, cobalt, zirconium, molybdene and tungsten;
said aluminum support contains magnesium;
magnesium is present in an amount from 1% to 5% by weight versus aluminum;
said sublayer is further overcoated with an organic precoat layer;
said phosphor or scintillator layer comprises needle-shaped phosphor crystals having an alkali metal halide as a matrix compound and a lanthanide as an activator compound;
said needle-shaped phosphor is a photostimulable CsBr:Eu phosphor.

Moreover in a method of preparing a radiation image phosphor or scintillator panel, said phosphor or scintillator layer is coated by a technique selected from the group consisting of physical vapor deposition, chemical vapor deposition and an atomization technique.

Furtheron in a method of preparing a radiation image phosphor or scintillator panel, said sublayer is coated by a technique selected from the group consisting of roller coating, knife coating, doctor blade coating, spray coating, sputtering, physical vapor deposition, chemical vapor deposition and electrochemical deposition.

Further advantages and particular embodiments of the present invention will become apparent from the following description, without however limiting the invention thereto.

### DETAILED DESCRIPTION OF THE INVENTION

Criticality of speed and speed loss, as well as occurrence of pittings, strongly depends on sublayer thickness. With respect thereof, nothing can be learnt e.g. from U.S. Pat. No. 5,881,645. Thicknesses of surface layers are expressed as derived from particle sizes of a material such as Al₂O₃, deposited by plasma spraying, a technique which leaves uncertainty with respect to roughness.

So it has been found now that, according to the present invention, in a radiation image phosphor or scintillator panel comprising, as a layer arrangement of consecutive layers, an anodized aluminium support, a sublayer and a phosphor or scintillator layer comprising needle-shaped crystals, a sublayer thickness advantageously is in the range from 0.1 to 2.5 μm.

According to the present invention a radiation image phosphor or scintillator panel advantageously comprises as a layer arrangement of consecutive layers: an anodized aluminium support, a sublayer having a thickness as disclosed above and a phosphor or scintillator layer comprising needle-shaped phosphor crystals, wherein said sublayer advantageously comprises an inorganic compound, i.e. an inorganic metal oxide or a metal compound, said metal being selected from the group consisting of tin, copper, nickel, chromium, scandium, yttrium, tantalum, vanadium, titanium, niobium, cobalt, zirconium, molybdene and tungsten.

In one embodiment according to the present invention said aluminum support contains magnesium.

In a more particular embodiment according to the present invention magnesium is present in an amount from 1% to 5% by weight versus aluminum.

Furtheron said sublayer is further advantageously overcoated with an organic precoat layer. Said organic precoat layer is thus present between the sublayer and the binderless phosphor or scintillator layer. In one embodiment thereof such an organic precoat layer is a poly-p-xylylene polymer layer. “Parylene C” is advantageously used therefor in favor of its good adhesion properties. General literature with respect to “parylene” polymer films can be found in e.g. Martin H. Kaufman, Herman F. Mark, and Robert B. Mesrobian, “Preparation, Properties and Structure of Polyhydro-carbons derived from p-Xylene and Related Compounds,” vol. XIII, 1954, pp. 3-20 and Andreas Griener, “Poly(1,4-xylylene)s: Polymer Films by Chemical Vapor Deposition,” 1997, vol. 5, No. 1, January, 1997, pp. 12-16. “Parylene”, a generic name for thermoplastic polymers and copolymers based on p-xylylene and substituted p-xylylene monomers, has been shown to possess suitable physical, chemical, electrical, and thermal properties for use in integrated circuits. Deposition of such polymers by vaporization and decomposition of a stable dimer, followed by deposition and polymerization of the resulting reactive monomer, has been discussed by Ashok K. Sharma in “Parylene-C at Subambient Temperatures”, published in the Journal of Polymer Science: Part A: Polymer Chemistry, Vol. 26, at pages 2953-2971 (1988). “Parylene” polymers are typically identified as Parylene-N, Parylene-C, and Parylene-F corresponding to non-substituted p-xylylene, chlorinated p-xylylene, and fluorinated p-xylylene, respectively. Properties of such polymeric materials, including their low dielectric constants, are further discussed by R. Olson in “Xylylene Polymers”, published in the Encyclopedia of Polymer Science and Engineering, Volume 17, Second Edition, at pages 990-1024 (1989). Parylene-N is deposited from non-substituted p-xylyene at temperatures below about 70-90° C. The substituted dimers are typically cracked at temperatures which degrade the substituted p-xylylene monomers, and the parylene-C and parylene-F films must be deposited at temperatures substantially lower than 30° C. As a basic agent the commercially available di-p-xylylene composition sold by the Union Carbide Co. under the trademark “Parylene” may advantageously be applied. Preferred compositions for a protective moisture-proof protective layer covering the phosphor or scintillator screens or panels are the unsubstituted “Parylene N”, the monochlorine substituted “Parylene C”, the dichlorine substituted “Parylene D” and the “Parylene HT” (a completely fluorine substituted version of Parylene N, opposite to the other “parylenes” resistant to heat up to a temperature of 400° C. and also resistant to ultra-violet radiation, moisture resistance being about the same as the moisture resistance of “Parylene C”: see the note about “High Performance Coating for Electronics Resist Hydrocarbons and High Temperature” written by Guy Hall, Specialty Coating Systems, Indianapolis, available via www.scscookson.com. Technology Letters have also been made available by Specialty Coating Systems, a Cookson Company, as e.g. the one about “Solvent Resistance of the Parylenes”, wherein the effect of a wide variety of organic solvents on Parylenes N, C, and D was investigated. In a preferred embodiment said parylene layer is a halogen-containing layer. More preferably said para-xylylene or “parylene” in the precoat layer of the phosphor or scintillator panel of the present invention is selected from the group consisting of Parylene D®, Parylene C® and Parylene HT®. In the present invention use is most favorably made from “Parylene C”® as the “Parylene C”® is exceptionally, besides offering good adhesion, in favor of preventing corrosion of the aluminum support. In another embodiment according to the present invention the precoat layer covering the sublayer in radiation image panels according to the present invention are polymers selected from the group consisting of cellyte, poly-acrylate, poly-methyl-methacrylate, poly-methyl-acrylate, polystyrene, polystyrene-acrylonitrile, polyurethane, hexafunctional acrylates, as e.g. “Ebecryl” from UCB, Belgium, poly-vinylidene-difluoride (PVDF), silane-based polymers and epoxy functionalized polymers. Furtheron polymers selected from the group consisting of silazane and siloxazane type polymers, mixtures thereof and mixtures of said silazane or siloxazane type polymers with compatible film-forming polymers may be applied in form of a solution, thus forming polymeric films thereof after drying. In still another embodiment barrier layers may be coated consisting of a organic-anorganic composite material, wherein the said composite material consists of a polymer containing a monomer functionalized with an alkoxy silane group which is further crosslinked by controlled hydrolysis and condensation with at least one metal alkoxide, most preferably an tetraalkoxysilane such as tetraethoxysilane. Sol-gel reactions, well-known in scientific literature, describe in its original form a chemical route to synthetize inorganic polymers like glass or ceramics via a colloidal phase in solution. The basic chemistry that may be applied therefor is known since about 150 years (see Ebelmen, “Untersuchungen uber die Verbindungen der Borsaüre und Kieselsaüre mit Ether”, Ann. 57 (1846), p. 319-355). The general sol-gel reaction scheme is composed of a series of hydrolysis steps in conjunction with condensation steps. During the growth reaction a colloid phase with particles or macromolecules in the nm range appear (sol) finally leading to a solid with a second phase within its pores. More recently the sol-gel reaction has been used to prepare inorganic-organic hybrid materials. In this general reaction hydrolysis and condensation of a metal alkoxide species such as TEOS take place, and a network is formed in the process. During the build-up of this anorganic network appropriately functionalized organic moieties that can also undergo the same condensation reaction as the hydrolyzed metal alkoxides are also incorporated in the network. Particular types of inorganic-organic hybrid materials are named ORMOCERS, ORMOSILS or CERAMERS. Scientific literature on inorganic-organic hybrid materials include: “The synthesis, structure and property behavior of inorganic-organic hybrid network materials prepared by the sol-gel process”, Wilkes at al., Proceedings of MRS Meeting, Boston Mass., November 1989; “Sol-gel processes II: investigation and application”, H. Reuter, Advanced Materials, 3 (1991) No 11, p. 568; “New inorganic-organic hybrid materials through the sol-gel approach”, Wilkes et al. “Electrical and electrochemical applications of Ormocers”, M. Popall and H. Schmidt, “Hybrid inorganic-organic materials by sol-gel processing of organo-functional metal alkoxides”, Schubert et al., Chem. Mater. (1995), 7, p. 2010-2027. Inorganic-organic composite materials are known to be used in a variety of industrial applications, but, it is to our knowledge the first time that their use in precoat barrier layers in storage phosphor or scintillator panels is disclosed. It is further not excluded to make use of a combination of polymers in the precoat layer covering the sublayer in the screen or panel as disclosed in the present invention in order to improve adhesion characteristics and in order to avoid corrosion of aluminum supports as envisaged.

In the preparation method of the screen or panel according the present invention said sublayer layer is coated by a technique selected from the group consisting of roller coating, knife coating, doctor blade coating, spray coating, sputtering, physical vapor deposition and chemical vapor deposition. Use of combined techniques is not excluded.

According to the method of preparing a radiation image phosphor or scintillator panel according to the present invention said phosphor or scintillator layer is coated by a technique selected from the group consisting of physical vapor deposition, chemical vapor deposition and an atomization technique.

Furtheron in the phosphor or scintillator panel according to the present invention, said stimulable phosphor or scintillator layer comprises needle-shaped phosphor or scintillator crystals having an alkali metal halide as a matrix compound and a lanthanide as an activator compound.

In a particular embodiment according to the present invention, the said needle-shaped phosphor is a photostimulable CsBr:Eu phosphor.

A photostimulable CsBr:Eu phosphor in form of needles, selected from a viewpoint of high sensitivity and high sharpness, is advantageously provided with amounts of Eu as an activator or dopant, in the range from 0.0001 to 0.01 mole/mole of CsBr, and more preferably from 0.0003 to 0.005 mole/mole. In the case of a stimulable CsBr:Eu phosphor, the europium compound of the evaporation source preferably may start from a divalent europium Eu²⁺ compound and a trivalent Eu³⁺ compound: said europium compound may be EuBrₓ in which x satisfies the condition of 2.0≦x≦2.3, wherein a europium compound containing the divalent europium compound as much as possible, i.e. at least 70%, is desired.

Although the thickness of the phosphor layer changes with the sensitivity class of the photostimulable phosphor, it is desirable to deposit a phosphor layer having a thickness from 100 μm to 1000 μm, more preferable from 200 μm to 800 μm, and still more preferable from 300 μm to 700 μm. Too thin a phosphor layer causes too little absorbed amounts of radiation, an increased transparency, and a deteriorated image quality of the obtained radiation image, whereas too thick a phosphor layer will cause image quality to decrease, due to a lowered sharpness.

In a method of preparing a radiation image storage panel according to the present invention, said phosphor layer is coated onto the sublayer by a technique selected from the group consisting of physical vapor deposition, chemical vapor deposition and an atomization technique. As an atomization technique, electron beam vaporization can be used, as has e.g. been described in U.S. Pat. Nos. 6,740,897 and 6,875,990 and in US-Applications 2002/050570, 2004/075062 and 2004/149931. In the electron beam evaporation technique, an electron beam generated by an electron gun is applied onto the evaporation source and an accelerating voltage of electron beam preferably is in the range of 1.5 kV to 5.0 kV. By applying the electron beam technique, the evaporation source of matrix component and activator element is heated, vaporized, and deposited on the substrate. Physical vapor deposition techniques as suitable for use in the deposition of binderless needle-shaped crystals in the phosphor layer of the present invention, such as resistive heating, sputtering and RF induction techniques. Resistive heating vacuum deposition, may advantageously be applied as has been described e.g. in U.S. Pat. Nos. 6,720,026; 6,730,243 and 6,802,991 and in US-Application 2001/007352, which are incorporated herein by reference. This technique is recommended as a method in order to vapor deposit the needle-shaped binderless storage phosphors for a panel according to the present invention. In the resistance heating evaporation, the evaporation sources are heated by supplying electrical energy to the resistance heating means: crucible or boat configurations—preferably composed of refractory materials—in a vapor deposition apparatus, in order to practically realize a homogeneous deposit of vapor deposited phosphor material may be applied as has e.g. been disclosed in US-Applications 2005/000411, 2005/000447 and 2005/217567, which are incorporated herein by reference.

Vapor deposition in a vacuum deposition apparatus requires adjustment of a predetermined degree of vacuum. For a binderless needle-shaped storage phosphor layer in a panel according to the present invention, formation of said phosphor under a high vacuum is desirable: the degree of vacuum of 1×10⁻⁵ to 5 Pa, and, more specifically, from 1×10⁻² to 2 Pa is desired, wherein an inert gas, such as an Ar or Ne noble gas, or alternatively, an inert gas as nitrogen gas, may be introduced into the vacuum deposition apparatus. Evacuation to give an even lower inner pressure of 1×10⁻⁵ to 1×10⁻² Pa is more preferred for electron beam evaporation. Introduction of oxygen or hydrogen gas may be advantageously performed, more particularly in order to enhance reactivity and/or e.g. in an annealing step. Introduction of an inert gas can moreover be performed in favor of cooling the vapor stream before deposition onto the substrate and/or the substrate, whereupon phosphor vapor raw materials should be deposited as disclosed in U.S. Pat. No. 6,720,026, which is incorporated herein by reference.

Alternatively one side of the support may be heated while the other side may be cooled while performing vapor deposition as disclosed in U.S. Pat. No. 7,029,836, which is incorporated herein by reference. The deposition rate generally is in the range of 0.1 to 1,000 μm/min., preferably in the range of 1 to 100 μm/min. It is not excluded to perform a pretreatment to the support, coated with the sublayer as in the present invention: in favor of an enforced drying step, the layer arrangement before phosphor deposition is held at a high temperature during a defined time. It is even not excluded to increase the percentage of relative humidity until the surface of the sublayer starts hydrating, in order to get a smooth base for the phosphor layer. Efficient deposition of the storage phosphor layer onto the substrate however, requires temperatures for the substrate in the range from 50° C. to 250° C. as has been disclosed in US-Application 2004/081750. Heating or cooling the substrate during the deposition process may thus be steered and controlled as required.

Phosphor raw materials comprising matrix and activator compounds are advantageously present as precursors in form of powders or tablets. Examples of phosphor precursor materials useful in the context of the present invention have been described in US-Applications 2005/184250, 2005/184271 and 2005/186,329, which are all incorporated herein by reference.

Evaporation may be performed from one or more crucibles. In the presence of more than one crucible, an independent vaporization control may be performed in favor of uniformity, homogeneity and/or dedicated incorporation of activator or dopant. This is more particularly preferred when differences in vapor pressure between matrix and activator compound are significant, as is the case e.g. for CsBr and EuOBr or EuBrₓ in which x satisfies the condition of 2.0≦x≦2.3

Average amounts of Europium dopant incorporated in the needle-shaped CsBr:Eu crystals are in the range from 150 to 750 μmol/mol, and more preferably in the range from 200 to 600 μmol/mol.

The formed phosphor layer comprises prismatic, needle-shaped stimulable phosphor crystals which are aligned almost perpendicularly to the substrate. The thus formed phosphor layer only comprises the stimulable phosphor, without presence of a binder, and there are produced cracks extending the depth direction in the phosphor layer. In favor of image quality, especially sharpness, the needle-shaped phosphor layer may advantageously be colored with a colorant which does not absorb the stimulated emission but the stimulating rays as has e.g. been described in U.S. Pat. No. 6,977,385, which is incorporated herein by reference.

After the deposition procedure is complete, the deposited layer is preferably subjected to heat treatment, also called “annealing”, which is carried out generally at a temperature of 100 to 300° C. for 0.5 to 3 hours, preferably at a temperature of 150 to 250° C. for 0.5 to 2 hours, under inert gas atmosphere which may contain a small amount of oxygen gas or hydrogen gas. Annealing procedures may be applied as described in U.S. Pat. Nos. 6,730,243; 6,815,692 and 6,852,357 or in US-Applications 2004/0131767, 2004/0188634, 2005/0040340 and 2005/0077477, which are incorporated herein by reference.

The layer arrangement of the screens or panels, consisting of a dedicated support whereupon a phosphor or scintillator layer is deposited as disclosed in the present invention, is further advantageously protected with a protective layer at the side of the phosphor or scintillator layer. A transparent protective film on the surface of the stimulable phosphor layer is advantageously applied in order to ensure good handling of the radiation image storage panel in transportation steps and in order to avoid deterioration and damaging. Chemically stable, physically strong, and of high moisture proof coatings are advantageously provided by overcoating the phosphor or scintillator layer with a solution in which an organic polymer (e.g., cellulose derivatives, polymethyl methacrylate, fluororesins soluble in organic solvents) is dissolved in a solvent, by placing a sheet prepared beforehand for the protective film (e.g., a film of organic polymer such as polyethylene terephthalate, a transparent glass plate) on the phosphor film with an adhesive, or by depositing vapor of inorganic compounds on the phosphor film. Protective layers may thus be composed of materials such as a cellulose acetate, nitrocellulose, polymethyl-methacrylate, polyvinyl-butyral, polyvinyl-formal, polycarbonate, polyester, polyethylene terephthalate, polyethylene, polyvinylidene chloride, nylon, polytetrafluoroethylene and tetrafluoroethylene-6 fluoride propylene copolymer, a vinylidene-chloride-vinyl chloride copolymer, and a vinylidene-chloride-acrylonitrile copolymer. A transparent glass support may also be used as a protective layer. Moreover, by vacuum deposition, making use e.g. of the sputtering technique, a protective layer of SiC, SiO2, SiN, and Al₂O₃ grade may be formed. Various additives may be dispersed in the protective film. Examples of the additives include light-scattering fine particles (e.g., particles of magnesium oxide, zinc oxide, titanium dioxide and alumina), a slipping agent (e.g., powders of perfluoroolefin resin and silicone resin) and a cross-linking agent (e.g. polyisocyanate). Preferred thicknesses of protective layers are in the range from 1 μm up to 20 μm for polymer coatings and even up to 2000 μm in case of inorganic materials as e.g. silicate glass. For enhancing the resistance to stain, a fluororesin layer is preferably provided on the protective film. Fluororesin layers may be formed by coating the surface of the protective film with a solution in which a fluororesin is dissolved or dispersed in an organic solvent, and drying the coated solution. The fluororesin may be used singly, but a mixture of the fluororesin and a film-forming resin may be employed. In the mixture, an oligomer having polysiloxane structure or perfluoroalkyl group may be added furtheron. In the fluororesin layer, a fine particle filler may be incorporated to reduce blotches caused by interference and to improve the quality of the resultant image. The thickness of the fluororesin layer is generally in the range of 0.5 to 20 μm. For forming such a fluororesin layer, additives such as a cross-linking agent, a film-hardening agent and an anti-yellowing agent may be used. In particular, the crosslinking agent is advantageously employed to improve durability of the fluororesin layer. In order to further improve the sharpness of the resultant image in a storage phosphor panel with a photostimulable phosphor, at least one layer may be colored with a colorant which does not absorb the stimulated emission, normally emitted in the wavelength range from 300 to 500 nm, but effectively absorbs the stimulating radiation in the wavelength range from 400 to 900 nm.

In another embodiment heating the phosphor plate in an organic solvent gas and sealing the phosphor plate with a moisture-proof protective film in order to prepare the radiation image storage panel as in published US-Application 2006/0049370, may be applied.

Further embodiments of protective layers suitable to be applied can be found in U.S. Pat. Nos. 6,710,356; 6,800,362; 6,822,243; 6,844,056; 6,864,491 and 6,984,829 and in US-Applications 2004/0164251, 2005/0067584, 2004/0183029, 2004/0228963, 2005/0104009, 2005/0121621, 2005/0139783, 2005/0211917, 2005/0218340, 2006/0027752 and 2006/0060792, which are all of them incorporated herein by reference, without however being limitative.

### EXAMPLES

While the present invention will hereinafter be described in connection with preferred embodiments thereof, it will be understood that it is not intended to limit the invention to those embodiments.

Magnesium in the aluminum layer support was present in an amount of 3 wt % in comparative plate CB73805 and in inventive plate CB73865. Mg was absent in the pure Al containing comparative support plate CB73804 and in inventive support plate CB73803.

Anodization treatment was performed in order to get an anodized layer having a thickness ‘t’ as indicated in Table 1 hereinafter. Treatment conditions of the anodized layer were performed as indicated in the Table 1 hereinafter.

The bare aluminum plate was first “degreased” during about 5 seconds with a sodium hydroxide solution at 70° C. in order to get a clean surface, free from contamination by e.g. oil, dust, and other undesired contaminants.

In a second step “graining” of the aluminum support was performed by an A.C. current in hydrogen chloride (alternatively in nitric acid).

In order to remove aluminum hydroxide formed during the graining step, a “desmutting” neutralizing step was applied wherein the aluminum plate was sprayed with sulphuric acid during a time of about 5 seconds at 70° C.

The “anodizing step” was performed by application of a D.C. current in sulphuric acid and was water sealed.

With respect to the meaning of roughness Rₐ of the anodized aluminum layer it should be taken in mind that Rₐ has been measured according to DIN4768 as an arithmetic average value of the departures of the roughness profile from the mean level line within an assessment length L, wherein the surface of the planes above and under the line are integrated in order to calculate said roughness Rₐ value.

Roughness ‘Rₐ’-values, expressed in μm, were thus calculated after having registered the surface roughness profile with a perth-o-meter. Samples were scanned therefor with a Dektak-8 Stylus Profiler and the values were calculated as described in DIN-4768.

Corrosion was evaluated on a “flat field” coated needle image plate and expressed as “number of pittings per 100 square cm”, i.e. per full plate. The term “flat field” should be understood as “uniformly exposed”, i.e. exposed with a constant intensity and with a homogeneous energy distribution in order to avoid “phantoms”. In a standard procedure thereof use is made therefor from RQA 5 (International Electrotechnical Commission—IEC61267:1994) beam quality.

No intermediate layer was present between sealed anodized support layer and needle phosphor layer for comparative plates CB73804 and CB73805.

For the inventive plates CB73865 and CB73803 an inorganic coating of electrochemically deposited tin (from a tin sulphate solution) and an inorganic coating of yttrium oxide, applied by chemical vapor deposition (CVD), as inorganic sublayers were applied respectively.

Results as obtained in Table 1 are illustrative for reduction of corrosion and a lowering of the degree of pitting.

TABLE 1

| Plate | Mg | | | Anodized | | |
|---|---|---|---|---|---|---|
| CB | in | | Anodization; | layer | Roughness | Pittings/ |
| No. | Al | Sublayer | sealing | thickness | ‘Rₐ’ (μm) | 100 cm² |
| 73804 | 0% | No | H₂SO₄; | 1 μm | 0.671 | >100 |
| | | | H₂O seal | | | |
| 73805 | 3% | No | H₂SO₄; | >20 μm | 0.487 | 50 |
| | | | H₂O seal | | | |
| 73865 | 3% | Sn | H₂SO₄; | 15 μm | 0.491 | 16 |
| | | | H₂O seal | | | |
| 73803 | 0% | Y₂O₃ | H₂SO₄; | 1 μm | | 30 |
| | | | H₂O seal | | | |

As can be concluded from the results summarized in the Table 1, an anodized aluminum support coated with an inorganic layer as is the case for inventive examples CB73865 (coated with a tin metal layer) or CB73803 (coated with an oxide coating of yttrium) provides a clearly better protection against corrosion, if compared with the comparative panels CB73804 and CB73805, without sublayer.

It is moreover clear that presence of magnesium in the aluminum support provides better protection against corrosion, for the inventive as well as for the comparative coatings. Protection with an inorganic coating of less than 10 μm moreover drastically improves the degree of pitting, by lowering it (CE73865).

TABLE 2

| | Phosphor | | | Speed after |
|---|---|---|---|---|
| Plate | coating wt. | Sublayer | Speed or | 7 days |
| No. | (mg/cm²) | thickness | sensitivity | 20° C./80% RH |
| CB73805 | 42.0 | 0 | 52 | 22 |
| CB73865 | 45.6 | <10 μm | 109 | 42 |
| CB73803 | 42.2 | 0.45 μm | 114 | 76 |

Table 2 is illustrative for the acceptable speed and speed decrease in severe conditions of high relative humidity during one week, more particularly for the panel wherein a thin oxide coating of yttrium oxide was present as a sublayer between anodized aluminum support and phosphor layer (CB73803).

Having described in detail preferred embodiments of the current invention, it will now be apparent to those skilled in the art that numerous modifications can be made therein without departing from the scope of the invention as defined in the appending claims.

What is claimed is:

1. A radiation image phosphor or scintillator panel comprising, as a layer arrangement of consecutive layers, an anodized aluminium support, a sublayer and a phosphor or scintillator layer comprising needle-shaped crystals, wherein said sublayer comprises an inorganic compound and in that said sublayer has a thickness in the range from 0.1 μm to 2.5 μm.

2. Panel according to claim 1, wherein said inorganic compound is a metal compound or a metal oxide compound.

3. Panel according to claim 2, wherein said metal is selected from the group consisting of tin, copper, nickel, chromium, scandium, yttrium, tantalum, vanadium, titanium, niobium, cobalt, zirconium, molybdene and tungsten.

4. Panel according to claim 1, wherein said aluminum support contains magnesium in an amount from 1% to 5% by weight versus aluminum.

5. Panel according to claim 2, wherein said aluminum support contains magnesium in an amount from 1% to 5% by weight versus aluminum.

6. Panel according to claim 3, wherein said aluminum support contains magnesium in an amount from 1% to 5% by weight versus aluminum.

7. Panel according to claim 1, wherein said sublayer is further overcoated with an organic precoat layer.

8. Panel according to claim 2, wherein said sublayer is further overcoated with an organic precoat layer.

9. Panel according to claim 3, wherein said sublayer is further overcoated with an organic precoat layer.

10. Panel according to claim 4, wherein said sublayer is further overcoated with an organic precoat layer.

11. Panel according to claim 1, wherein said phosphor or scintillator layer comprises needle-shaped phosphor crystals having an alkali metal halide as a matrix compound and a lanthanide as an activator compound.

12. Panel according to claim 2, wherein said phosphor or scintillator layer comprises needle-shaped phosphor crystals having an alkali metal halide as a matrix compound and a lanthanide as an activator compound.

13. Panel according to claim 3, wherein said phosphor or scintillator layer comprises needle-shaped phosphor crystals having an alkali metal halide as a matrix compound and a lanthanide as an activator compound.

14. Panel according to claim 4, wherein said phosphor or scintillator layer comprises needle-shaped phosphor crystals having an alkali metal halide as a matrix compound and a lanthanide as an activator compound.

15. Panel according to claim 1, wherein said needle-shaped phosphor is a photostimulable CsBr:Eu phosphor.

16. Panel according to claim 2, wherein said needle-shaped phosphor is a photostimulable CsBr:Eu phosphor.

17. Panel according to claim 3, wherein said needle-shaped phosphor is a photostimulable CsBr:Eu phosphor.

18. Panel according to claim 4, wherein said needle-shaped phosphor is a photostimulable CsBr:Eu phosphor.

19. Method of preparing a radiation image phosphor or scintillator panel according to claim 1, wherein said phosphor or scintillator layer is coated by a technique selected from the group consisting of physical vapor deposition, chemical vapor deposition and an atomization technique.

20. Method of preparing a radiation image phosphor or scintillator panel according to claim 1, wherein said sublayer is coated by a technique selected from the group consisting of roller coating, knife coating, doctor blade coating, spray coating, sputtering, physical vapor deposition, chemical vapor deposition and electrochemical deposition.
